(19) United States
(12) Patent Application Publication
(10) Pub. No.: US 2015/0222876 A1
(43) Pub. Date: Aug. 6, 2015

(54) BREAST SURGERY GUIDANCE BASED ON BREAST MR IMAGES AND RADIOACTIVE MARKERS

(71) Applicant: KONINKLIJKE PHILIPS N.V., EINDHOVEN (NL)

(72) Inventors: Thomas Buelow, Grosshansdorf (DE); Cristian Lorenz, Hamburg (DE); Sven Kabus, Hamburg (DE); Bjoern Eiben, Sutton Courtenay (GB); David John Hawkes, Crawley (GB); John Harold Hipwell, London (GB); Mohammad Keshtgar, Essex (GB)

(73) Assignee: KONINKLIJKE PHILIPS N.V., EINDHOVEN (NL)

(21) Appl. No.: 14/425,649

(22) PCT Filed: Sep. 13, 2013
(86) PCT No.: PCT/IB2013/058521

§ 371 Date: Mar. 4, 2015

Related U.S. Application Data
(60) Provisional application No. 61/775,758, filed on Mar. 11, 2013.
(60) Provisional application No. 61/700,494, filed on Sep. 13, 2012.

(51) Int. Cl. H04N 13/02; G06T 5/00; G06T 7/00

(52) U.S. Cl. CPC H04N 13/0203; G06T 7/0012; G06T 5/001; G06T 2207/30096; G06T 2207/10088; G06T 2207/30068

(57) ABSTRACT

A system and method are provided for guiding surgery using MR images and radioactive markers. The method comprises reconstructing the surface of an anatomical structure and a gamma probe orientated to optimize a radioactivity reading from a radioactive seed placed at a target location in the anatomic structure for each of one or more positions of the gamma probe. The position and orientation of the gamma probe is detected in each reconstructed surface to estimate a position of the radioactive seed relative to the reconstructed surface.

### FIELD OF THE INVENTION

The invention relates to the field of medical imaging and more particularly to guided surgery using MR images and radioactive markers.

### BACKGROUND

The most common imaging modalities used in image based diagnostic work-up of abnormalities in the breast are: x-ray mammography, ultrasound, and dynamic contrast enhanced (DCE) magnetic resonance imaging (MRI). One of the uses of DCE MRI is planning of a surgical removal of a tumor (lumpectomy). Breast MRI has been shown to be superior to ultrasound and x-ray imaging with regard to the estimation of tumor shape and extent.

DCE breast MRI is commonly performed with the patient in a prone position and the breast positioned in dedicated breast MRI coils. In contrast, during breast surgery, the patient is in a supine position. The repositioning of the patient from a prone position with the breast in dedicated MRI coils to a supine position leads to significant deformations of the breast. These deformations make it difficult to guide the surgical procedure with the available MR information.

Typically, to provide guidance during breast surgery for removal of a tumor, a guide-wire is placed in the breast prior to surgery to locate the tumor. The guide-wire is placed with one of its ends in the tumor and the other end extending through the skin to the outside. However, the guide-wire, which is typically placed with x-ray is not placed with the patient in a supine position and does not always provide the best path after deformation from the change in position. Also, the guide-wire does not provide real time information on the shape and extent of the tumor.

Recently, approaches have been suggested in which the guide-wire is replaced by a radioactive seed placed in the tumor that can be located using a gamma-camera or gamma probe. These approaches, while indicating the real time position of the tumor, do not give any indication of the extent of the tumor or provide other information contained in the prone MR images, such as positions and shapes of internal structures.

### SUMMARY

A system and method are provided for surgical guidance using MR images and radioactive markers.

According to one aspect of the present invention, a system is provided for guiding surgery using MR images and radioactive markers. The method comprises reconstructing the surface of an anatomical structure and a gamma probe orientated to optimize a radioactivity reading from a radioactive seed placed at a target location in the anatomic structure for each of one or more positions of the gamma probe. The position and orientation of the gamma probe is detected in each reconstructed surface to estimate a position of the radioactive seed relative to the reconstructed surface.

According to one embodiment, the method further comprises the step of warping a model volume of the anatomic structure using the estimated position of the radioactive seed and reconstructed surface.

According to one embodiment, the method further comprises the steps of: detecting a surface of the anatomic structure in the model volume of the anatomic structure; and performing a non-rigid registration of the model volume to the reconstructed surface using the detected surface and the reconstructed surface.

According to one embodiment the non-rigid registration further uses a known orientation of the anatomic structure and at least one landmark on the anatomic structure.

According to one embodiment, the anatomic structure is deformed by a change in position, the detected surface is acquired from the model volume before deformation of the anatomic structure using MR images, and the reconstructed surface is acquired after deformation of the anatomic structure using a three dimensional (3D) camera.

According to one embodiment, the anatomic structure is a breast and the region of interest is a tumor.

According to one embodiment fiducials are placed on the surface of the anatomic structure and used in the registration step.

According to one embodiment, portions of the surface that are not obstructed by the gamma probe in the 3D camera images are used to compensate for patient motion.

According to one embodiment, a method for guiding tumor surgery using MR images and radioactive markers is provided. A radioactive seed is placed at a target location. Pre-operative MR images of an anatomic structure containing the target location are obtained. A model volume is constructed from the MR images. The radioactive seed and a surface contour of the anatomic structure are located in the model volume. A surface of the anatomic structure is reconstructed using images from a 3D camera. The model volume is aligned to the reconstructed surface with a non-rigid registration algorithm. The radioactive seed is located using a gamma probe at one or more positions relative to the anatomic structure. The surface of the anatomical structure and the gamma probe are reconstructed for each position of the gamma probe. The position and orientation of the gamma probe are used in each reconstructed surface to estimate a position of the radioactive seed. The model volume is warped using the estimated position of the radioactive seed.

According to another aspect of the present invention, a system is provided for guiding surgery using MR images and radioactive markers. The system comprises: a 3D camera, a gamma probe, at least one processor, operably connected with the 3D camera, at least one memory, operably connected with the at least one processor, and at least one program of instruction stored on the at least one memory and executable by the at least one processor. The program of instruction reconstructs the surface of the anatomical structure and a gamma probe oriented to optimize a radioactivity reading for each of at least one positions of the gamma probe using images from the 3D camera, detects the position and orientation of the gamma probe in each reconstructed surface to estimate a position of the radioactive seed relative to the reconstructed surface, and warps a model volume of the anatomic structure using the estimated position of the radioactive seed and reconstructed surface.

According to one embodiment, the processor is embodied in a radiology workstation.

According to one embodiment, the 3D camera is operably connected to the workstation through a thin client computer in the operating room.

According to one embodiment, the system further comprises a display, and the program of instruction presents the warped model volume on the display.

According to another aspect of the present invention, a computer program product is provided. The computer program product comprises a computer-readable storage device having encoded thereon a computer-executable program of instruction. The program of instruction comprises: program instructions for reconstructing the surface of the anatomical structure and a gamma probe oriented to optimize a radioactivity reading from a radioactive seed placed at a target location in the anatomic structure for each of one or more positions of the gamma probe, program instructions for detecting the position and orientation of the gamma probe in each reconstructed surface to estimate a position of the radioactive seed relative to the reconstructed surface, and program instructions for warping a model volume of the anatomic structure using the estimated position of the radioactive seed and reconstructed surface.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of a system for method for guiding surgery using MR images and radioactive markers according to an embodiment of the present invention;

FIG. 2 shows a camera capturing a gamma probe and a surface of an anatomic structure using a 3D camera according to an embodiment of the present invention;

FIG. 3 shows how the location of a radioactive seed is triangulated using a gamma probe according to an embodiment of the present invention;

FIG. 4 is a flow diagram of a method for guiding surgery using MR images and radioactive markers according to an embodiment of the present invention.

### DETAILED DESCRIPTION

The present invention provides a method, system, and computer program product for surgical guidance using MR images and radioactive markers.

According to one embodiment, a method is provided comprising locating a radioactive seed placed at a target location in an anatomic structure using a gamma probe at one or more positions relative to the anatomic structure. The surface of the anatomical structure and the gamma probe is reconstructed for each position of the gamma probe. The position and orientation of the gamma probe is determined in each reconstructed surface to estimate a position of the radioactive seed relative to the reconstructed surface. Then, a model volume of the anatomic structure is warped using the estimated position of the radioactive seed and reconstructed surface.

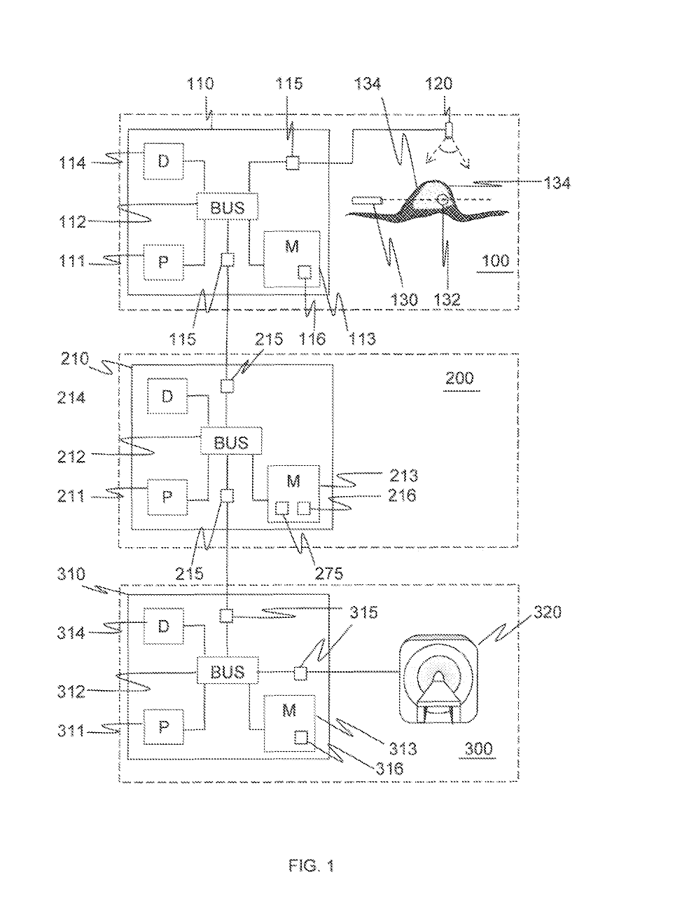

FIG. 1 is a block diagram of an imaging system 100 for surgical guidance using MR images and radioactive markers. The imaging system comprises a gamma probe 130 for locating a radioactive seed 132 that has been preoperatively placed at a target location or location of interest, such as a tumor. The radioactive seed may be a titanium capsule filled with Iodine 125 (I¹²⁵), for example. The radioactive seed may be placed at the target location using image guidance, such as x-ray mammography or ultrasound capable of providing visualization of the area of interest (such as a tumor) and the radioactive seed.

The gamma probe 130 may be any probe or camera that can provide a directional indication of radioactivity. For example, ant of a variety of gamma probes available form Nuclear Fields USA Corp. may be used. While the illustrated embodiment uses a gamma probe, which detects gamma radiation, equivalent probes may also be used which detect other forms of radiation emitted by compatible radioactive seeds. The gamma probe 130 provides an indication of radiation intensity, such as a display, for example.

The imaging system further comprises a three dimensional (3D) camera 120. The 3D camera may be any stereo camera or camera pair which can take two or more simultaneous frames or images at a set distance from each other to allow ranging. Alternatively, the 3D camera can be a single image camera with coded light (a set grid pattern) and/or with time of flight measurement. The 3D camera is operably connected to a processor 211 such as through one or more I/O connectors 115, 215 and one or more system busses 112, 212, for example.

The processor 211 may be any device capable of executing program instructions, such as one or more microprocessors. Moreover, the processor 211 may be embodied in a general purpose computer. In the illustrated embodiment, the processor 211 is embodied in an imaging workstation 200 with a thin client computer 110 in an operating room operably connecting the 3D camera 120 to the workstation 200. The thin client computer 110 has its own processor 111, system bus 112, memory 113, display 114, and I/O connectors 115.

A memory 213 is operably connected to the processor 211 such as by a system bus 212 for example. The memory 213 may be any volatile or non-volatile memory device suitable for storing data and program instructions, such as a removable disc, a hard drive, a CD, a Random Access Memory (RAM), a Read Only Memory (ROM), or the like. Moreover, the memory 213 may comprise one or more memory devices.

The I/O connectors 115, 215 may be any hardware that operably connects the processors 111 to the 3D camera, to each other, and/or to a data source. The I/O connectors may include, but are not limited to RS232 serial interface, Ethernet, and USB ports.

The imaging system 100 further comprises an imaging program 275 stored on the memory 213 and executed by the processor 211 to receive and process imaging data from the 3D camera 120 and volume model data from a volumetric imaging system 300, such as a magnetic resonance imaging (MRI) system. The imaging program provides surgical guidance using the MR images and radioactive markers. A registered and warped volume model is presented on a monitor 114 for surgical guidance. The imaging program 275 may include modules or units for various image processing functions.

The imaging program 275 may be a part of a work station modeling program, a stand-alone program, or a sub-routine callable by a radiography or modeling workstation. Alternatively, the imaging program 275 may be loaded on an imaging workstation for processing 3D camera images in the operating room.

Both the MR images and the 3D camera image data provide a location of the radioactive seed 132. The radioactive seed is visible in the MR images, and the position of the radioactive seed can be derived from the position and orientation of a gamma probe 130 in the 3D camera images. The positions of the radioactive seed are used to warp the volume model to compensate for tissue deformation from the change in the patient's position between the pre-procedural MR images and the intra-procedural 3D camera images.

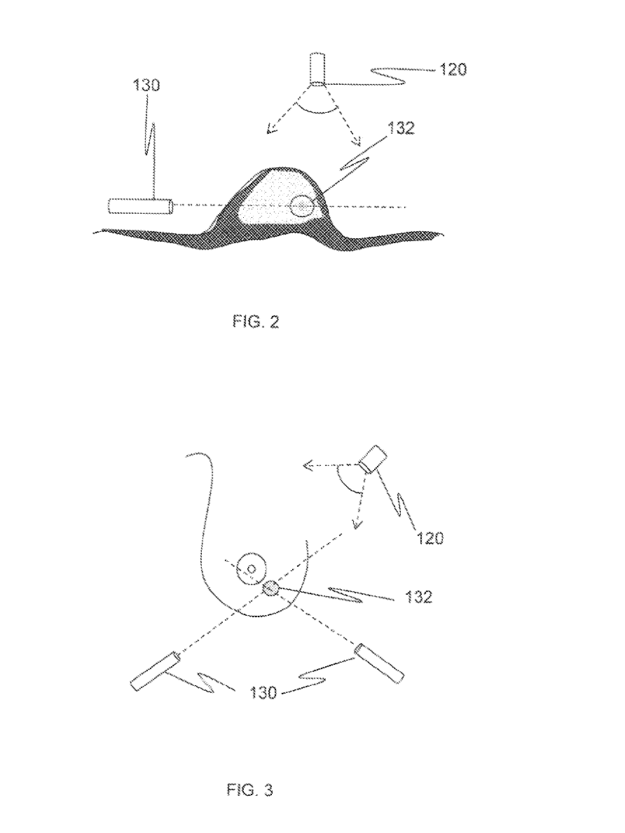

FIG. 2 shows the present invention being used to locate a radioactive seed 132 placed in a lesion in a breast. To determine the position of the radioactive seed 132 with respect to the 3D camera images, a gamma probe 130 is manipulated to adjust its orientation until a maximum radiation reading is obtained, as shown in FIG. 2. At the orientation with the maximum reading, the gamma probe is pointed at the radioactive seed. The 3D camera 120 captures both the surface contour and the position and orientation of the gamma probe 130. The axis of the gamma probe can then be extended to define a pointing line or sight line on which the radioactive seed 132 lies.

As shown in FIG. 3, the gamma probe 130 may be aligned with the radioactive seed 132 from several locations and the resulting sight lines are overlaid onto each other and used to define the location of the radioactive seed 132 at the intersection of the sight lines. The gamma probe 130 may be repositioned multiple times to more precisely locate the radioactive seed 132. Alternatively, two or more gamma probes 130 may be used simultaneously to provide intersecting sight lines.

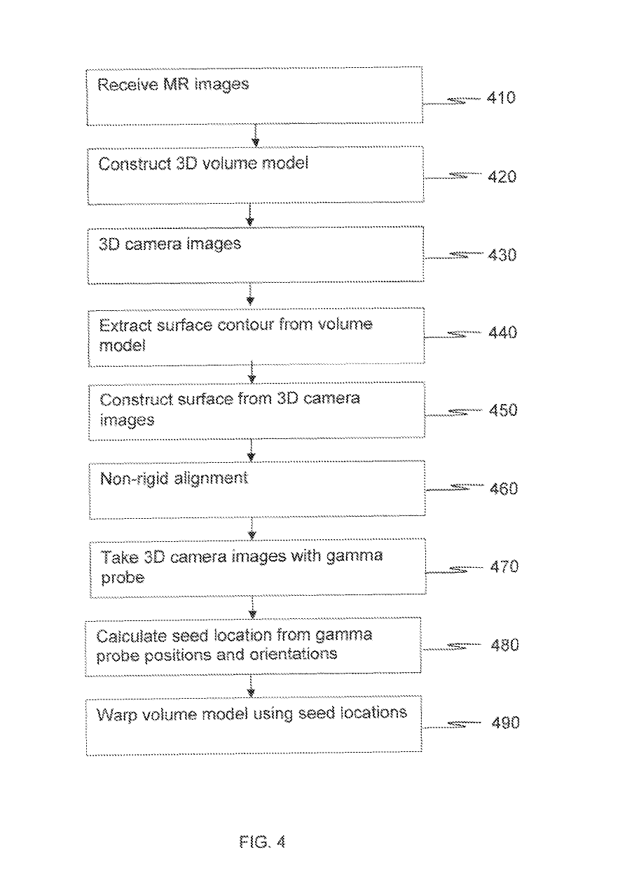

FIG. 4 is a flow diagram of a method for guiding surgery using MR images and radioactive markers according to an embodiment of the present invention. In the following description, the radioactive seed 132 is placed in a lesion in a breast. However, the radioactive seed 132 could be placed at or in a different region of interest. Also, the invention can be used in a different anatomic structure.

According to one embodiment, the imaging program 275 receives MR imaging data from an MRI machine 300 (Step 410). The MRI machine 300 may comprise a processor 311 operably connected to a memory 313 through a bus 312. An MRI imaging program 316 may be stored on the memory 313 and executed by the processor 311 to construct a three-dimensional volume model of the breast with the radiographic seed 132 placed in a lesion, therein. Alternatively, raw MR imaging data may be sent to the workstation 200 and be processed by the workstation to construct a volume model (Step 420). As will be understood by those skilled in the art, the MR imaging and construction of the volume model are typically performed prior to the intervention and at a different location.

During the intervention procedure, the 3D camera 120 is used to provide images of the breast surface (Step 430). Optionally, 3D images may be taken prior to introduction of the gamma probe to allow the entire surface to be visible for surface reconstruction. Alternatively, the 3D images may be taken after the gamma probe 130 or gamma probes 130 are in place.

The imaging program 275 extracts the surface contour of the breast from the volume model (Step 440). The surface contour may be extracted using an edge detection program or any other method appropriate for defining a surface in a volume model.

The imaging program 275 also constructs a surface from the 3D images (Step 450). The surface reconstruction may be performed using the Iterative Close Point (ICP) approach, for example.

The imaging program 275 registers the surface contour from the MR images to the surface from the 3D camera images. According to one embodiment, the registration is based on known orientation of the patient (e.g., directions of the head, feet) and at least one landmark (e.g., nipple). The registration may be performed using any non-rigid registration method. This registration step gives a coarse estimate of the position of the internal beast structures, including the lesion or tumor. With at least one point (landmark) identified in the images of both modalities, translation in thee mutually perpendicular coordinates (x, y, z) can be resolved. With known orientation of the patient (direction of the head, angle of imaging device to table/patient) rotation about these axes may be resolved.

Optionally, fiducial markers 134 may be placed on the breast surface and imaged by both the MR and the 3D camera in order to provide additional landmarks supporting the registration of the two imaging modalities and provide a more accurate registration.

The imaging program 275 determines the position of the radioactive seed 132 in the MR image volume model. In the MR image, the position of the radioactive seed is either marked manually by the user, marked automatically by a computerized detection program (such as an edge detection program), or is marked manually by a user and auto-corrected by a computerized method.

After acquisition of the first 3D surface image in the operating room, a gamma probe 130 is used to locate the radioactive seed in the breast (Step 460). As shown in FIG. 2, the gamma probe 130 is positioned close to the breast and oriented in order to achieve a maximum signal. By adjusting the orientation of the gamma probe 130 and noting the measured radioactivity, the maximum reading is iteratively determined The maximum radioactivity corresponds to the gamma probe being oriented pointing directly at the radioactive seed 132. Accordingly, the position and orientation of the gamma probe defines a pointing line or line of sight on which the radioactive seed 132 lies.

The radioactive seed can be located with the gamma probe from multiple positions for use in calculating the 3D position of the radioactive seed relative to the breast surface. At each position, an optimized position (i.e., orientation of the gamma probe maximizing the radioactivity reading) is determined.

To facilitate linking the seed position identified by the gamma probe 130 to the coordinate frame of the 3D reconstructed breast surface, the imaging program 275 acquires a 3D camera image of the breast surface and the gamma probe for each optimized position of the gamma probe (Step 470). Then, the imaging program 275 reconstructs the surface of the anatomical structure and the gamma probe for each optimized position of the gamma probe. These reconstructed surfaces with the gamma probe show the position and orientation of the gamma probe relative to the reconstructed surface. As with the previous surface reconstruction, an ICP algorithm may be used, for example. Alternatively, any other approach to surface reconstruction may be used.

The imaging program 275 detects the position and orientation of the gamma probe in each reconstructed surface to estimate a position of the radioactive seed (Step 480). The position and orientation of the gamma probe may be determined with a model-based detection algorithm, for example. By triangulation, the location of the radioactive seed 132 with respect to the reconstructed surface of the breast may be determined.

The imaging program 275 Warps the model volume using the estimated position of the radioactive seed (Step 490). The MR volume model can be warped to the surface reconstruction, to which it is registered, above. The MR model volume is warped by deforming the breast so that the location of the radioactive seed in the MR model volume coincides with the location of the radioactive seed from the reconstructed surface and the contour of the breast in the MR volume model coincides with the surface contour from the reconstructed surface. The deformation may be performed by finite element analysis, for example. Alternatively, any other method for approximating non-linear deformation may be used.

According to one embodiment, only one position of the gamma probe is acquired, and instead of the position of the radioactive seed 132 being known, only a line on which the radioactive seed lies is known in the coordinate system of the surface reconstruction. This line is used as information in warping the anatomic structure in the MR volume model.

According to one embodiment, the radioactive seed 132 is placed in a lesion and tracked during a surgery using 3D camera images of the surface of an anatomic structure, such as a breast, and a gamma probe 130. The imaging program uses the seed position information with respect to the surface reconstruction provided by the gamma probe position and orientation to update an estimate of the current position and extent of the lesion by local registration, restricted to translation of the estimated position.

According to one embodiment, non-obstructed portions of a breast surface in the 3D surface reconstructions can be used to compensate for potential patient motion, such as from breathing, for example.

The invention can take the form of an entirely hardware embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable storage device providing program code for use by or in connection with a computer or any instruction execution system or device. For the purposes of this description, a computer-usable or computer readable storage device may be any apparatus that can contain or store the program for use by or in connection with the instruction execution system, apparatus, or device.

The foregoing method may be realized by a program product comprising a machine-readable storage device having a machine-executable program of instructions encoded thereon, which when executed by a machine, such as a computer, performs the steps of the method. This program product may be stored on any of a variety of known machine-readable storage devices, including but not limited to compact discs, floppy discs, USB memory devices, and the like.

The storage device can be an electronic, magnetic, optical, electromagnetic, infrared, or semiconductor system (or apparatus or device). Examples of a computer-readable storage device include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The preceding description and accompanying drawing are intended to be illustrative and not limiting of the invention. The scope of the invention is intended to encompass equivalent variations and configurations to the full extent of the following claims.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain features are recited in mutually different claims does not indicate that a combination of these features cannot be used to advantage. Any reference signs in the claims should not be construed as limiting the scope of the invention.

1. (canceled)

2. (canceled)

3. (canceled)

4. (canceled)

5. (canceled)

1. A method for guiding surgery using MR images and radioactive markers comprising the steps of:
acquiring images of a surface of an anatomical structure and a gamma probe for each of one or more positions of the gamma probe using an imaging system, the anatomical structure having a radioactive seed placed at a target location therein, the gamma probe being oriented to maximize a strength of a radioactivity reading from the radioactive seed placed at a target location in the anatomic structure;
reconstructing the surface of the anatomical structure and the gamma probe for each of the one or more positions of the gamma probe using the acquired images;
detecting the position and orientation of the gamma probe in each reconstructed surface to estimate a position of the radioactive seed relative to the reconstructed surface; and
warping a previously acquired model volume of the anatomic structure using the estimated position of the radioactive seed and the reconstructed surface.

2. The method of claim 1, further comprising the steps of:
detecting a surface of the anatomic structure in the model volume of the anatomic structure; and
performing a non-rigid registration of the model volume to the reconstructed surface using the detected surface and the reconstructed surface.

3. The method of claim 1, wherein the non-rigid registration further uses a known orientation of the anatomic structure and at least one landmark on the anatomic structure.

4. The method of claim 1, wherein the anatomic structure is deformed by a change in position, the detected surface is acquired form the model volume before deformation of the anatomic structure using MR images, and the reconstructed surface is acquired after deformation of the anatomic structure using a three dimensional (3D) camera.

5. The method of claim 1, wherein the anatomic structure is a breast and the region of interest is a tumor.

6. The method of claim 1, wherein fiducials are placed on the surface of the anatomic structure and used in the registration step.

7. The method of claim 1, wherein portions of the surface that are not obstructed by the gamma probe in the 3D camera images are used to compensate for patient motion.

8. A method for guiding tumor surgery using MR images and radioactive markers, comprising the steps of:
placing a radioactive seed at a target location;
acquiring pre-operative MR images of an anatomic structure containing the target location;
constructing a model volume from the MR images;
locating the radioactive seed and a surface contour of the anatomic structure in the model volume;
reconstructing a surface of the anatomic using images from a 3D camera;
aligning the model volume to the reconstructed surface with a non-rigid registration algorithm;
locating the radioactive seed using a gamma probe at one or more positions relative to the anatomic structure;
reconstructing the surface of the anatomical structure and the gamma probe for each position of the gamma probe;
detecting the position and orientation of the gamma probe in each reconstructed surface to estimate a position of the radioactive seed; and
warping the model volume using the estimated position of the radioactive seed.

9. A system for guiding surgery using MR images and radioactive markers, comprising:
a 3D camera;
a gamma probe;
at least one processor, operably connected with the 3D camera;
at least one memory, operably connected with the at least one processor; and
at least one program of instruction stored on the at least one memory and executable by the at least one processor to:
acquire images of a surface of an anatomical structure and a gamma probe for each of one or more positions of the gamma probe using an imaging system, the anatomical structure having a radioactive seed placed at a target location therein, the gamma probe being oriented to maximize a strength of a radioactivity reading from the radioactive seed placed at a target location in the anatomic structure;
reconstruct the surface of the anatomical structure and the gamma probe for each of at least one positions of the gamma probe using images from the 3D camera;
detect the position and orientation of the gamma probe in each reconstructed surface to estimate a position of the radioactive seed relative to the reconstructed surface; and
warp a previously acquired model volume of the anatomic structure using the estimated position of the radioactive seed and reconstructed surface.

10. The system of claim 1, wherein the processor is embodied in a radiology workstation.

11. The system of claim 1, wherein the 3D camera is operably connected to the workstation through a thin client computer in the operating room.

12. The system of claim 1, further comprising a display, and wherein the program of instruction presents the warped model volume on the display.

13. A computer program product for, comprising a computer-readable storage device having encoded thereon a computer-executable program of instruction, the program instruction comprising:
program instructions for acquiring images of a surface of an anatomical structure and a gamma probe for each of one or more positions of the gamma probe using an imaging system, the anatomical structure having a radioactive seed placed at a target location therein, the gamma probe being oriented to maximize a strength of a radioactivity reading from the radioactive seed placed at a target location in the anatomic structure;
program locations for reconstructing the surface of the anatomical structure and the gamma probe for each of one or more positions of the gamma probe;
program instructions for detecting the position and orientation of the gamma probe in each reconstructed surface to estimate a position of the radioactive seed relative to the reconstructed surface; and
program instructions for warping a previously acquired model volume of the anatomic structure using the estimated position of the radioactive seed and reconstructed surface.
